(19) United States
(12) Patent Application Publication
(10) Pub. No.: US 2007/0025697 A1
(43) Pub. Date: Feb. 1, 2007

(54) Recording medium, method and apparatus for reproducing data, and method and apparatus for recording data

(75) Inventors: Kun Suk Kim, Anyang-si (KR); Jea Yong Yoo, Seongnam-si (KR)

Correspondence Address: HARNESS, DICKEY & PIERCE, P.L.C., P.O. BOX 8910, RESTON, VA, 20195, US

(73) Assignee: LG Electronics Inc.

(21) Appl. No.: 11/493,899

(22) Filed: Jul. 27, 2006

Related U.S. Application Data
(60) Provisional application No. 60/703,462, filed on Jul. 29, 2005.
(60) Provisional application No. 60/709,807, filed on Aug. 22, 2005.
(60) Provisional application No. 60/737,412, filed on Nov. 17, 2005.

(30) Foreign Application Priority Data
Apr. 3, 2006 (KR) 10-2006-0030106

(51) Int. Cl. H04N 7/00

(52) U.S. Cl. 386/95

(57) ABSTRACT

In one embodiment, a primary video stream and a secondary video stream are stored in a data area of the recording medium. The primary video stream represents a primary presentation path, and the secondary video stream represents a picture-in-picture presentation path with respect to the primary presentation path. Management information for managing reproduction of the picture-in-picture presentation path is stored in a management area of the recording medium. The management information indicates a type of the secondary video data stream based on whether the secondary video data stream is multiplexed with the primary video data stream.

### DOMESTIC PRIORITY INFORMATION

This application claims the benefit of the U.S. Provisional Application Nos. 60/703,462, 60/709,807, and 60/737,412 filed Jul. 29, 2005, Aug. 22, 2005, and Nov. 17, 2005, which are all hereby incorporated by reference in their entirety.

### BACKGROUND OF THE INVENTION

### FOREIGN PRIORITY INFORMATION

1. Field of the Invention

The present invention relates to recording and reproducing methods and apparatuses, and a recording medium.

2. Discussion of the Related Art

Optical discs are widely used as a recording medium capable of recording a large amount of data therein. Particularly, high-density optical recording mediums such as a Blu-ray Disc (BD) and a high definition digital versatile disc (HD-DVD) have recently been developed, and are capable of recording and storing large amounts of high-quality video data and high-quality audio data.

Such a high-density optical recording medium, which is based on next-generation recording medium techniques, is considered to be a next-generation optical recording solution capable of storing much more data than conventional DVDs. Development of high-density optical recording mediums is being conducted, together with other digital appliances. Also, an optical recording/reproducing apparatus, to which the standard for high density recording mediums is applied, is under development.

In accordance with the development of high-density recording mediums and optical recording/reproducing apparatuses, it is possible to simultaneously reproduce a plurality of videos. However, there is known no method capable of effectively simultaneously recording or reproducing a plurality of videos. Furthermore, it is difficult to develop a complete optical recording/reproducing apparatus based on high-density recording mediums because there is no completely-established standard for high- density recording mediums.

### SUMMARY OF THE INVENTION

The present invention relates to a recording medium having a data structure for managing reproduction of at least one picture-in-picture presentation path.

In one embodiment, a primary video stream and a secondary video stream are stored in a data area of the recording medium. The primary video stream represents a primary presentation path, and the secondary video stream represents a picture-in-picture presentation path with respect to the primary presentation path. Management information for managing reproduction of the picture-in-picture presentation path is stored in a management area of the recording medium. The management information indicates a type of the secondary video data stream based on whether the secondary video data stream is multiplexed with the primary video data stream.

In one embodiment, the management information includes a sub path type information field indicating whether the secondary video stream is one of a multiplexed type of picture-in-picture presentation path and a not multiplexed type of picture-in-picture presentation path.

In an embodiment, the data area stores the primary video stream and the secondary video stream in a single file if the sub path type information field indicates the secondary video stream is multiplexed with the primary video stream, and stores the primary video stream and the secondary video stream in separate files if the sub path type information field indicates the secondary video stream is not multiplexed with the primary video stream.

In another embodiment, the management information includes a sub path type information field indicating one of a plurality of picture-in-picture presentation path types, and at least one of the types indicates whether the secondary video stream is multiplexed with the primary video stream.

In one embodiment, a primary video stream and a secondary video stream are stored in a data area of the recording medium. The primary video stream represents a primary presentation path, and the secondary video stream represents a picture-in-picture presentation path with respect to the primary presentation path. Management information for managing reproduction of the picture-in-picture presentation path is stored in a management area of the recording medium. The management information indicates whether the secondary video stream is multiplexed with the primary video stream.

The present invention also relates to methods and apparatuses for managing reproduction of at least one picture-in-picture presentation path, and further relates to methods and apparatuses for recording a data structure for managing reproduction of at least one picture-in-picture presentation path.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings:

FIG. 1 is a schematic view illustrating an exemplary embodiment of the combined use of an optical recording/reproducing apparatus according to an embodiment of the present invention and a peripheral appliance;

FIG. 2 is a schematic diagram illustrating a structure of files recorded in an optical disc as a recording medium according to an embodiment of the present invention;

FIG. 3 is a schematic diagram illustrating a data recording structure of the optical disc as the recording medium according to an embodiment of the present invention;

FIG. 4 is a schematic diagram for understanding a concept of a secondary video according to an embodiment of the present invention;

FIG. 5 is a block diagram illustrating an overall configuration of an optical recording/reproducing apparatus according to an embodiment of the present invention;

FIG. 6 is a schematic diagram explaining a playback system according to an embodiment of the present invention;

FIG. 7 is a schematic diagram illustrating an exemplary embodiment of secondary video metadata according to the present invention;

FIG. 8 is a schematic diagram illustrating the kinds of secondary video sub path types according to an embodiment of the present invention;

FIGS. 9A to 9C are schematic diagrams for understanding of the secondary video sub path types according to embodiments of the present invention, respectively;

FIG. 10 is a block diagram schematically illustrating an AV decoder model according to an embodiment of the present invention;

FIGS. 11A to 11C are schematic diagrams for understanding of secondary video timeline types according to embodiments of the present invention; and

FIG. 12 is a flow chart illustrating an exemplary embodiment of a data reproducing method according to the present invention.

### DETAILED DESCRIPTION OF EXAMPLE EMBODIMENTS

Reference will now be made in detail to example embodiments of the present invention, which are illustrated in the accompanying drawings. Wherever possible, the same reference numbers will be used throughout the drawings to refer to the same or like parts. 100281 In the following description, example embodiments of the present invention will be described in conjunction with an optical disc as an example recording medium. In particular, a Blu-ray disc (BD) is used as an example recording medium, for the convenience of description. However, it will be appreciated that the technical idea of the present invention is applicable to other recording mediums, for example, HD-DVD, equivalently to the BD.

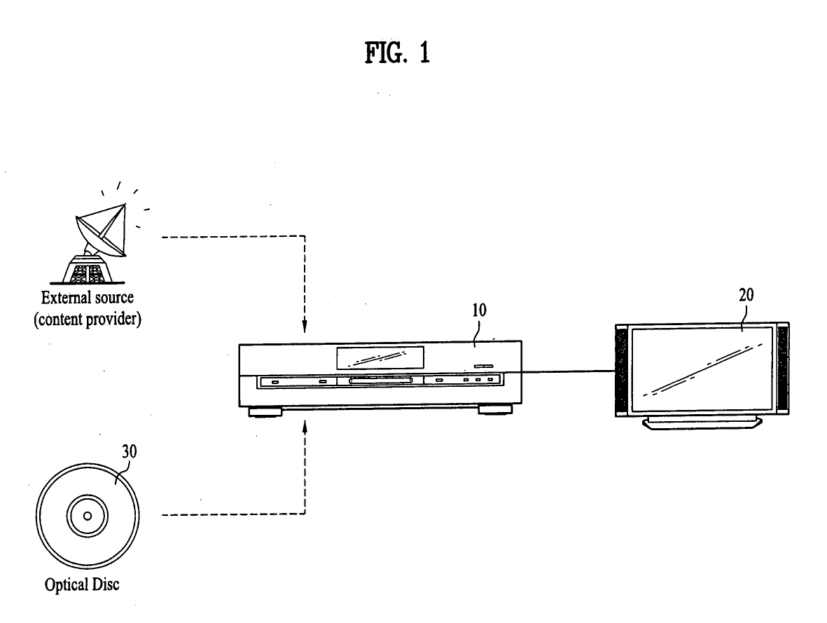

“Storage” as generally used in the embodiments is a storage equipped in a optical recording/reproducing apparatus (FIG. 1). The storage is an element in which the user freely stores required information and data, to subsequently use the information and data. For storages, which are generally used, there are a hard disk, a system memory, a flash memory, and the like. However, the present invention is not limited to such storages.

In association with the present invention, the “storage” is also usable as means for storing data associated with a recording medium (for example, a BD). Generally, the data stored in the storage in association with the recording medium is externally-downloaded data.

As for such data, it will be appreciated that partially-allowed data directly read out from the recording medium, or system data produced in association with recording and production of the recording medium (for example, metadata) can be stored in the storage.

For the convenience of description, in the following description, the data recorded in the recording medium will be referred to as “original data”, whereas the data stored in the storage in association with the recording medium will be referred to as “additional data”.

Also, “title” defined in the present invention means a reproduction unit interfaced with the user. Titles are linked with particular objects, respectively. Accordingly, streams recorded in a disc in association with a title are reproduced in accordance with a command or program in an object linked with the title. In particular, for the convenience of description, in the following description, among the titles including video data according to an MPEG compression scheme, titles supporting features such as seamless multi-angle and multi story, language credits, director's cuts, trilogy collections, etc. will be referred to as “High Definition Movie (HDMV) titles”. Also, among the titles including video data according to an MPEG compression scheme, titles providing a fully programmable application environment with network connectivity thereby enabling the content provider to create high interactivity will be referred to as “BD-J titles”.

FIG. 1 illustrates an exemplary embodiment of the combined use of an optical recording/reproducing apparatus according to the present invention and a peripheral appliance.

The optical recording/reproducing apparatus 10 according to an embodiment of the present invention can record or reproduce data in/from various optical discs having different formats. If necessary, the optical recording/reproducing apparatus 10 may be designed to have recording and reproducing functions only for optical discs of a particular format (for example, BD), or to have a reproducing function alone, except for a recording function. In the following description, however, the optical recording/reproducing apparatus 10 will be described in conjunction with, for example, a BD-player for playback of a BD, or a BD-recorder for recording and playback of a BD, taking into consideration the compatibility of BDs with peripheral appliances, which must be solved in the present invention. It will be appreciated that the optical recording/reproducing apparatus 10 of the present invention may be a drive which can be built in a computer or the like.

The optical recording/reproducing apparatus 10 of the present invention not only has a function for recording and playback of an optical disc 30, but also has a function for receiving an external input signal, processing the received signal, and sending the processed signal to the user in the form of a visible image through an external display 20. Although there is no particular limitation on external input signals, representative external input signals may be digital multimedia broadcasting-based signals, Internet-based signals, etc. Specifically, as to Internet-based signals, desired data on the Internet can be used after being downloaded through the optical recording/reproducing apparatus 10 because the Internet is a medium easily accessible by any person.

In the following description, persons who provide contents as external sources will be collectively referred to as a “content provider (CP)”.

“Content” as used in the present invention may be the content of a title, and in this case means data provided by the author of the associated recording medium.

Hereinafter, original data and additional data will be described in detail. For example, a multiplexed AV stream of a certain title may be recorded in an optical disc as original data of the optical disc. In this case, an audio stream (for example, Korean audio stream) different from the audio stream of the original data (for example, English) may be provided as additional data via the Internet. Some users may desire to download the audio stream (for example, Korean audio stream) corresponding to the additional data from the Internet, to reproduce the downloaded audio stream along with the AV stream corresponding to the original data, or to reproduce the additional data alone. To this end, it is desirable to provide a systematic method capable of determining the relation between the original data and the additional data, and performing management/reproduction of the original data and additional data, based on the results of the determination, at the request of the user.

As described above, for the convenience of description, signals recorded in a disc have been referred to as “original data”, and signals present outside the disc have been referred to as “additional data”. However, the definition of the original data and additional data is only to classify data usable in the present invention in accordance with data acquisition methods. Accordingly, the original data and additional data should not be limited to particular data. Data of any attribute may be used as additional data as long as the data is present outside an optical disc recorded with original data, and has a relation with the original data.

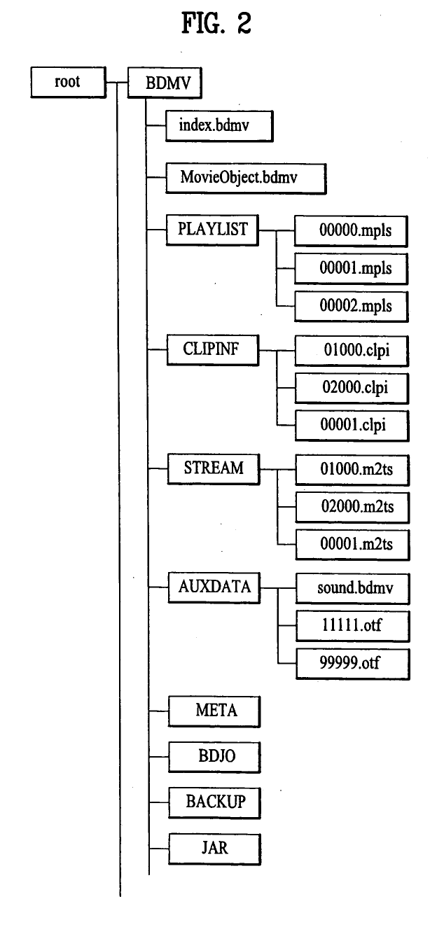

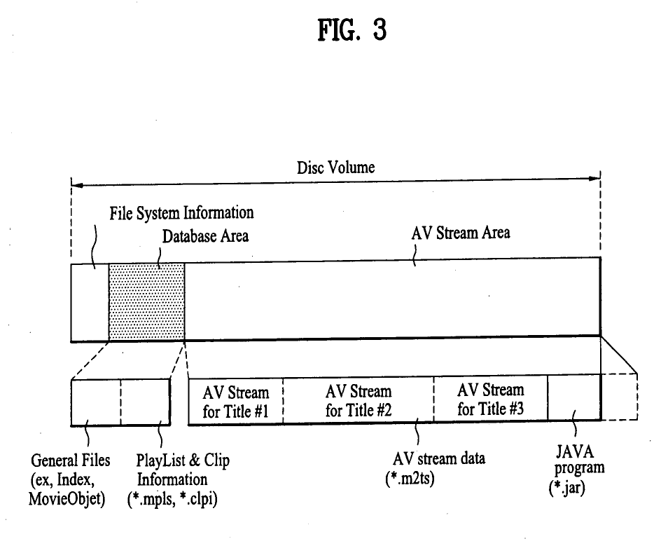

In order to accomplish the request of the user, the original data and additional data must have file structures having a relation therebetween, respectively. Hereinafter, file structures and data recording structures usable in a BD will be described with reference to FIGS. 2 and 3.

FIG. 2 illustrates a file structure for reproduction and management of original data recorded in a BD in accordance with an embodiment of the present invention.

The file structure of the present invention includes a root directory, and at least one BDMV directory BDMV present under the root directory. In the BDMV directory BDMV, there are an index file “index.bdmv” and an object file “MovieObject.bdmv” as general files (upper files) having information for securing an interactivity with the user. The file structure of the present invention also includes directories having information as to the data actually recorded in the disc, and information as to a method for reproducing the recorded data, namely, a playlist directory PLAYLIST, a clip information directory CLIPINF, a stream directory STREAM, an auxiliary directory AUXDATA, a BD-J directory BDJO, a metadata directory META, a backup directory BACKUP, and a JAR directory. Hereinafter, the above-described directories and files included in the directories will be described in detail.

The JAR directory includes JAVA program files.

The metadata directory META includes a file of data about data, namely, a metadata file. Such a metadata file may include a search file and a metadata file for a disc library. Such metadata files are used for efficient search and management of data during the recording and reproduction of data.

The BD-J directory BDJO includes a BD-J object file for reproduction of a BD-J title.

The auxiliary directory AUXDATA includes an additional data file for playback of the disc. For example, the auxiliary directory AUXDATA may include a “Sound.bdmv” file for providing sound data when an interactive graphics function is executed, and “11111.otf” and “99999.otf” files for providing font information during the playback of the disc.

The stream directory STREAM includes a plurality of files of AV streams recorded in the disc according to a particular format. Most generally, such streams are recorded in the form of MPEG-2-based transport packets. The stream directory STREAM uses “*.m2ts” as an extension name of stream files (for example, 01000.m2ts, 02000.m2ts, . . .). Particularly, a multiplexed stream of video/audio/graphic information is referred to as an “AV stream”. A title is composed of at least one AV stream file.

The clip information (clip-info) directory CLIPINF includes clip-info files 01000.clpi, 02000.clpi, . . . respectively corresponding to the stream files “*.m2ts” included in the stream directory STREAM. Particularly, the clip-info files “*.clpi” are recorded with attribute information and timing information of the stream files “*.m2ts”. Each clip- info file “*.clpi” and the stream file “*.m2ts” corresponding to the clip-info file “*.clpi” are collectively referred to as a “clip”. That is, a clip is indicative of data including both one stream file “*.m2ts” and one clip-info file “*.clpi” corresponding to the stream file “*.ni2ts”.

The playlist directory PLAYLIST includes a plurality of playlist files “*.mpls”. “Playlist” means a combination of playing intervals of clips. Each playing interval is referred to as a “playitem”. Each playlist file “*.mpls” includes at least one playitem, and may include at least one subplayitem. Each of the playitems and subplayitems includes information as to the reproduction start time IN-Time and reproduction end time OUT-Time of a particular clip to be reproduced. Accordingly, a playlist may be a combination of playitems.

As to the playlist files, a process for reproducing data using at least one playitem in a playlist file is defined as a “main path”, and a process for reproducing data using one subplayitem is defined as a “sub path”. The main path provides master presentation of the associated playlist, and the sub path provides auxiliary presentation associated with the master presentation. Each playlist file should include one main path. Each playlist file also includes at least one sub path, the number of which is determined depending on the presence or absence of subplayitems. Thus, each playlist file is a basic reproduction/management file unit in the overall reproduction/management file structure for reproduction of a desired clip or clips based on a combination of one or more playitems.

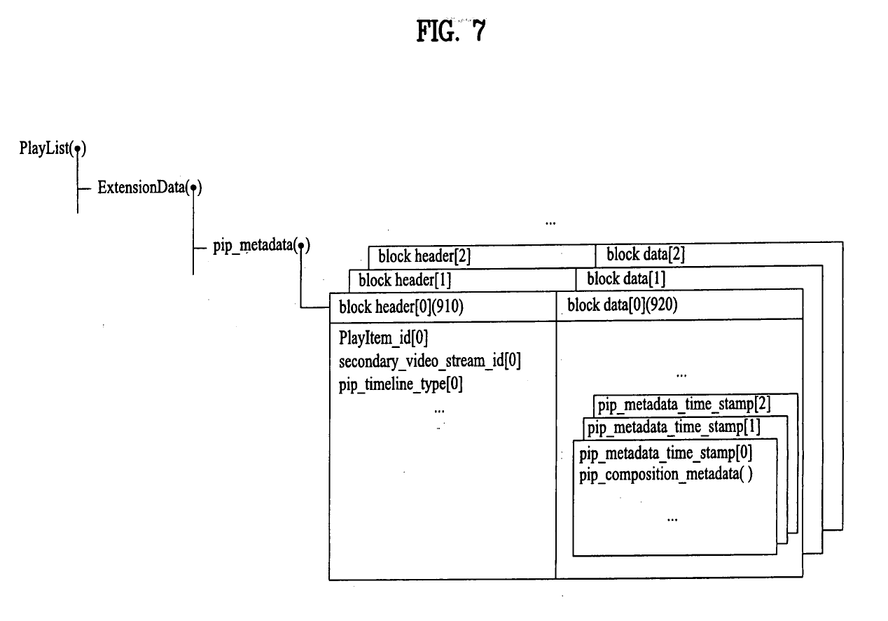

In association with the present invention, video data, which is reproduced through a main path, is referred to as a primary video, whereas video data, which is reproduced through a sub path, is referred to as a secondary video. The function of the optical recording/reproducing apparatus for simultaneously reproducing primary and secondary videos is also referred to as a “picture-in-picture (PiP)”. In the present invention, the type of a sub path used to reproduce a secondary video is classified based on characteristics of the sub path, and information indicating the classified type of the sub path is provided. This will be described in detail with reference to FIG. 7.

The backup directory BACKUP stores a copy of the files in the above-described file structure, in particular, copies of files recorded with information associated with playback of the disc, for example, a copy of the index file “index.bdmv”, object files “MovieObject.bdmv” and “BD-“Object.bdmv”, unit key files, all playlist files “*.mpls” in the playlist directory PLAYLIST, and all clip-info files “*.clpi” in the clip-info directory CLIPINF. The backup directory BACKUP is adapted to separately store a copy of files for backup purposes, taking into consideration the fact that, when any of the above-described files is damaged or lost, fatal errors may be generated in association with playback of the disc.

Meanwhile, it will be appreciated that the file structure of the present invention is not limited to the above-described names and locations. That is, the above-described directories and files should not be understood through the names and locations thereof, but should be understood through the meaning thereof.

FIG. 3 illustrates a data recording structure of the optical disc according to an embodiment of the present invention. In FIG. 3, recorded structures of information associated with the file structures in the disc are illustrated. Referring to FIG. 3, it can be seen that the disc includes a file system information area recorded with system information for managing the overall file, an area recorded with the index file, object file, playlist files, clip-info files, and meta files (which are required for reproduction of recorded streams “*.m2ts”), a stream area recorded with streams each composed of audio/video/graphic data or STREAM files, and a JAR area recorded with JAVA program files. The areas are arranged in the above- descried order when viewing from the inner periphery of the disc.

In the disc, there is an area for recording file information for reproduction of contents in the stream area. This area is referred to as a “management area”. The file system information area and database area are included in the management area.

The areas of FIG. 3 are shown and described only for illustrative purposes. It will be appreciated that the present invention is not limited to the area arrangement of FIG. 3.

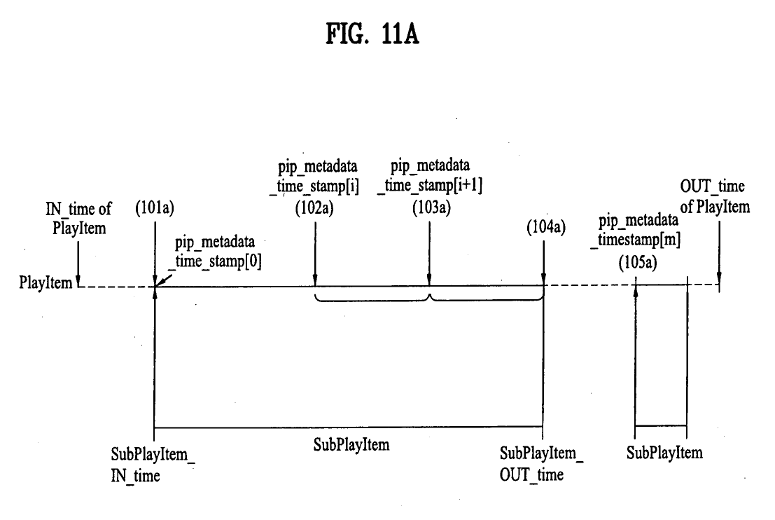

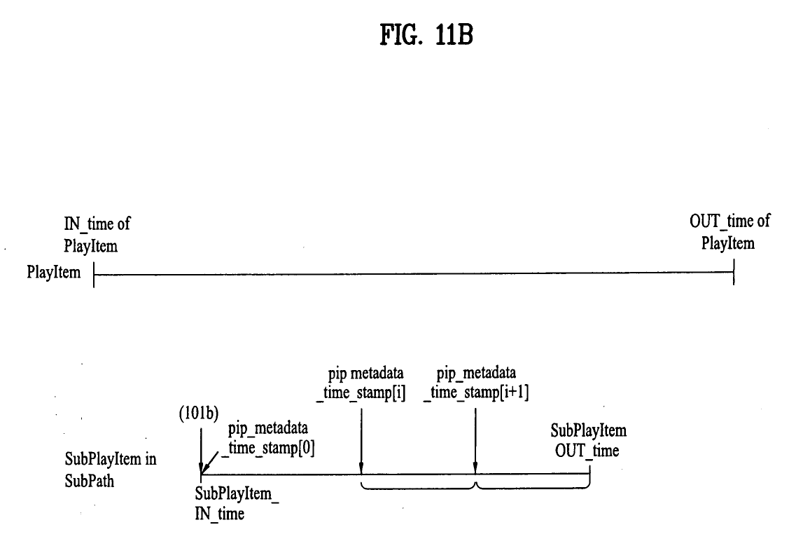

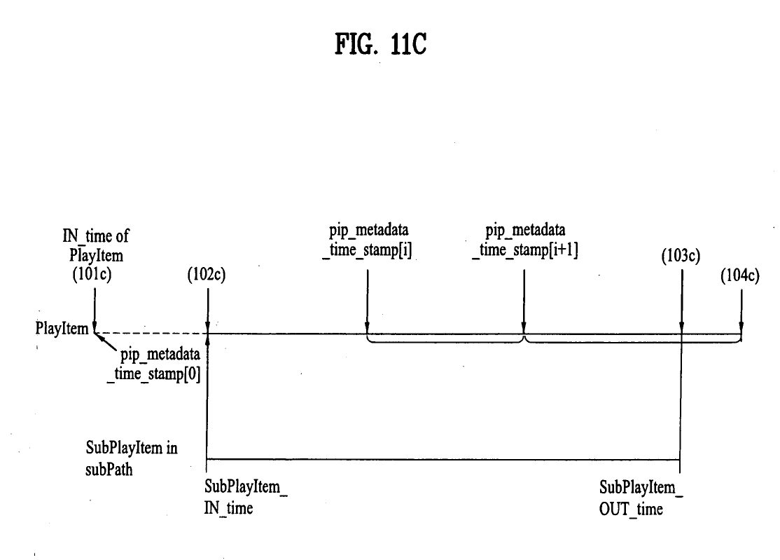

In accordance with the present invention, stream data of a primary video and/or a secondary video is stored in the stream area. In the present invention, the secondary video may be multiplexed in the same stream as the primary video, or may be multiplexed in a stream different from that of the primary video. In the present invention, information indicating the type of a sub path used to reproduce the secondary video, namely, the sub path type, is stored in the management area. The sub path type may be classified based on the kind of a stream in which the secondary video is multiplexed. Meanwhile, in accordance with the present invention, information as to the timeline type of secondary video metadata is stored in the management area. The secondary video metadata is data for managing reproduction of the secondary video. The timeline type information represents the timeline on which the metadata is defined. The metadata and timeline type will be described in detail with reference to FIG. 7 and FIGS. 11A to 11C.

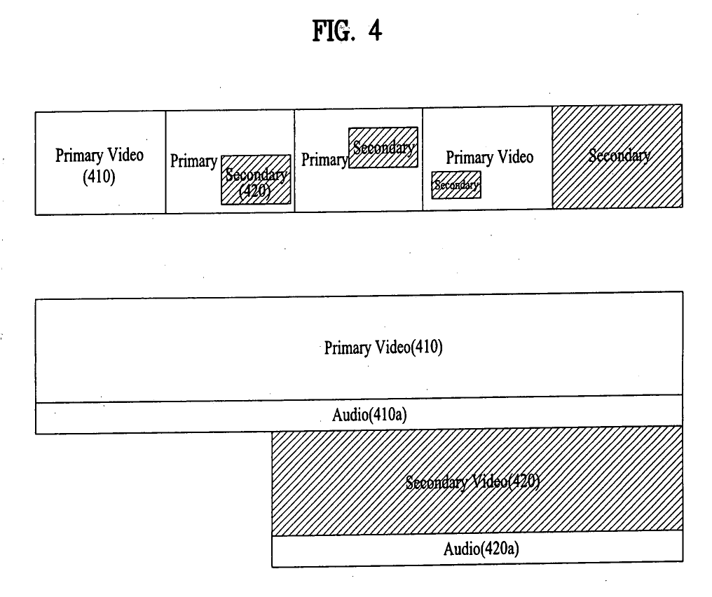

FIG. 4 is a schematic diagram for understanding of the concept of the secondary video according to embodiments of the present invention.

The present invention provides a method for reproducing secondary video data, simultaneously with primary video data. For example, the present invention provides an optical recording/reproducing apparatus that enables a PiP application, and, in particular, effectively performs the PiP application.

During reproduction of a primary video 410 as shown in FIG. 4, it may be necessary to output other video data associated with the primary video 410 through the same display 20 as that of the primary video 410. In accordance with the present invention, such a PiP application can be achieved. For example, during playback of a movie or documentary, it is possible to provide, to the user, the comments of the director or episode associated with the shooting procedure. In this case, the video of the comments or episode is a secondary video 420. The secondary video 420 can be reproduced simultaneously with the primary video 410, from the beginning of the reproduction of the primary video 410.

The reproduction of the secondary video 420 may be begun at an intermediate time of the reproduction of the primary video 410. It is also possible to display the secondary video 420 while varying the position or size of the secondary video 420 on the screen, depending on the reproduction procedure. A plurality of secondary videos 420 may also be implemented. In this case, the secondary videos 420 may be reproduced, separately from one another, during the reproduction of the primary video 410. The primary video 410 can be reproduced along with an audio 410a associated with the primary video 410. Similarly, the secondary video 420 can be reproduced along with an audio 420a associated with the secondary video 420.

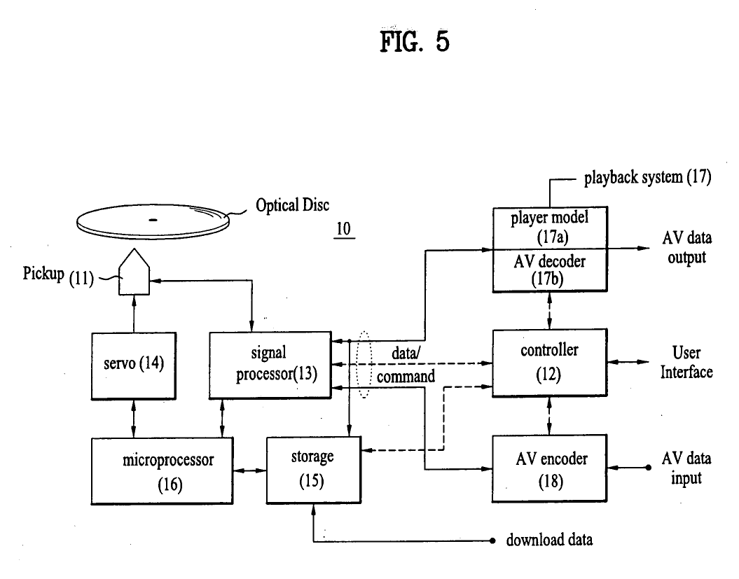

For reproduction of the secondary video, the AV stream, in which the secondary video is multiplexed, is identified and the secondary video is separated from the AV stream, for decoding of the secondary video. Accordingly, information is provided as to the encoding method applied to the secondary video and the kind of the stream in which the secondary video is encoded. Also, information as to whether or not the primary and secondary videos should be synchronous with each other is provided. In addition, information is provided as to the composition of the secondary video and as to the timeline on which the secondary video is composed. The present invention provides a preferable method capable of satisfying the above-described requirements, and efficiently reproducing the secondary video along with the primary video. Hereinafter, the present invention will be described in detail with reference to FIG. 5 and the remaining drawings.

FIG. 5 illustrates an exemplary embodiment of the overall configuration of the optical recording/reproducing apparatus 10 according to the present invention.

As shown in FIG. 5, the optical recording/reproducing apparatus 10 mainly includes a pickup 11, a servo 14, a signal processor 13, and a microprocessor 16. The pickup 11 reproduces original data and management data recorded in an optical disc. The management data includes reproduction management file information. The servo 14 controls operation of the pickup 11. The signal processor 13 receives a reproduced signal from the pickup 11, and restores the received reproduced signal to a desired signal value. The signal processor 13 also modulates signals to be recorded, for example, primary and secondary videos, to signals recordable in the optical disc, respectively. The microprocessor 16 controls the operations of the pickup 11, the servo 14, and the signal processor 13. The pickup 11, the servo 14, the signal processor 13, and the microprocessor 16 are also collectively referred to as a “recording/reproducing unit”. In accordance with the present invention, the recording/reproducing unit reads data from an optical disc 30 or storage 15 under the control of a controller 12, and sends the read data to an AV decoder 17b. That is, in a viewpoint of reproduction, the recording/reproducing unit functions as a reader unit for reading data. The recording/reproducing unit also receives an encoded signal from an AV encoder 18, and records the received signal in the optical disc 30. Thus, the recording/reproducing unit can record video and audio data in the optical disc 30.

The controller 12 downloads additional data present outside the optical disc 30 in accordance with a user command, and stores the additional data in the storage 15. The controller 12 also reproduces the additional data stored in the storage 15 and/or the original data in the optical disc 30 at the request of the user. In accordance with the present invention, the controller 12 generates sub path type information, based on the kind of the stream in which the secondary video is multiplexed, and whether or not the secondary video is synchronous with the primary video, and performs a control operation for recording the sub path type information in the optical disc 30, along with video data. The controller 12 also generates timeline type information indicating the timeline referred to by the secondary video metadata, and performs a control operation for recording the timeline type information in the optical disc 30, along with the metadata.

The optical recording/reproducing apparatus 10 further includes a playback system 17 for decoding data, and providing the decoded data to the user under the control of the controller 12. The playback system 17 includes an AV decoder 17b for decoding an AV signal. The playback system 17 also includes a player model 17a for analyzing an object command or application associated with playback of a particular title, and a user command input via the controller 12, and determining a playback direction, based on the results of the analysis. In an embodiment, the player model 17a may be implemented as including the AV decoder 17b. In this case, the playback system 17 is the player model itself. The AV decoder 17b may include a plurality of decoders respectively associated with different kinds of signals.

The AV encoder 18, which is also included in the optical recording/reproducing apparatus 10 of the present invention, converts an input signal to a signal of a particular format, for example, an MPEG2 transport stream, and sends the converted signal to the signal processor 13, to enable recording of the input signal in the optical disc 30.

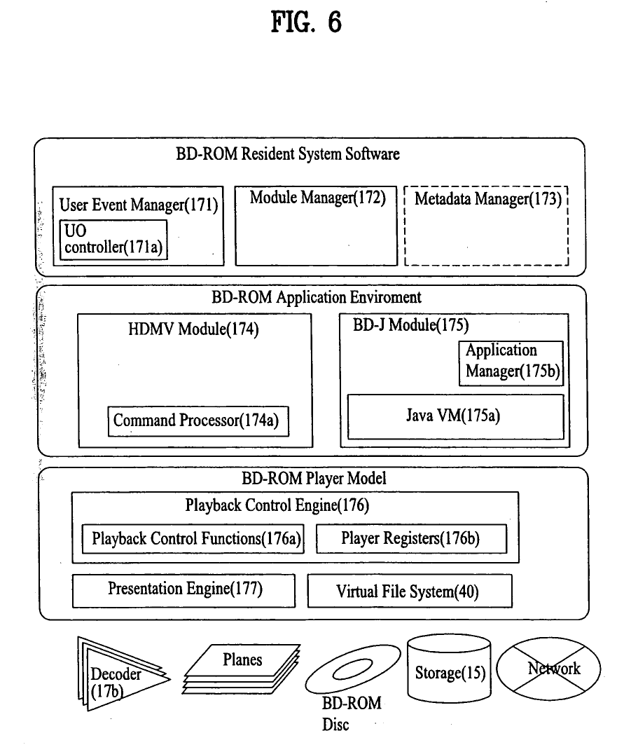

FIG. 6 is a schematic diagram explaining the playback system according to an embodiment of the present invention. In accordance with the present invention, the playback system can simultaneously reproduce the primary and secondary videos.

“Playback system” means a collective reproduction processing means which is configured by programs (software) and/or hardware provided in the optical recording/reproducing apparatus. That is, the playback system is a system which can not only play back a recording medium loaded in the optical recording/reproducing apparatus, but also can reproduce and manage data stored in the storage of the apparatus in association with the recording medium (for example, after being downloaded from the outside of the recording medium).

In particular, as shown in FIG. 6, the playback system 17 may include a user event manager 171, a module manager 172, a metadata manager 173, an HDMV module 174, a BD-J module 175, a playback control engine 176, a presentation engine 177, and a virtual file system 40. This configuration will be described in detail, hereinafter.

As a separate reproduction processing/managing means for reproduction of HDMV titles and BD-J titles, the HDMV module 174 for HDMV titles and the BD-J module 175 for BD-J titles are constructed independently of each other. Each of the HDMV module 174 and BD-J module 175 has a control function for receiving a command or program contained in the associated object “Movie Object” or “BD-J Object”, and processing the received command or program. Each of the HDMV module 174 and BD-J module 175 can separate an associated command or application from the hardware configuration of the playback system, to enable portability of the command or application. For reception and processing of the command, the HDMV module 174 includes a command processor 174a. For reception and processing of the application, the BD-J module 175 includes a Java Virtual Machine (VM) 175a, and an application manager 175b.

The Java VM 175a is a virtual machine in which an application is executed. The application manager 175b includes an application management function for managing the life cycle of an application processed in the BD-J module 175.

The module manager 172 functions not only to send user commands to the HDMV module 174 and BD-J module 175, respectively, but also to control operations of the HDMV module 174 and BD-J module 175. A playback control engine 176 analyzes the playlist file actually recorded in the disc in accordance with a playback command from the HDMV module 174 or BD-J module 175, and performs a playback function based on the results of the analysis. The presentation engine 177 decodes a particular stream managed in association with reproduction thereof by the playback control engine 176, and displays the decoded stream in a displayed picture. In particular, the playback control engine 176 includes playback control functions 176a for managing all playback operations, and player registers 176b for storing information as to the playback status and playback environment of the player (information of player status registers (PSRs) and general purpose registers (GPRs)). In some cases, the playback control functions 176a mean the playback control engine 176 itself.

The HDMV module 174 and BD-J module 175 receive user commands in independent manners, respectively. The user command processing methods of HDMV module 174 and BD-J module 175 are also independent of each other. In order to transfer a user command to an associated one of the HDMV module 174 and BD-J module 175, a separate transfer means should be used. In accordance with the present invention, this function is carried out by the user event manager 171. Accordingly, when the user event manager 171 receives a user command generated through a user operation (UO) controller 171a, the user event manager sends the received user command to the module manager 172 or UO controller 171a. On the other hand, when the user event manager 171 receives a user command generated through a key event, the user event manager sends the received user command to the Java VM 175a in the BD-J module 175.

The playback system 17 of the present invention may also include a metadata manager 173. The metadata manager 173 provides, to the user, a disc library and an enhanced search metadata application. The metadata manager 173 can perform selection of a title under the control of the user. The metadata manager 173 can also provide, to the user, recording medium and title metadata.

The module manager 172, HDMV module 174, BD-J module 175, and playback control engine 176 of the playback system according to the present invention can perform desired processing in a software manner. Practically, the processing using software is advantageous in terms of design, as compared to processing using a hardware configuration. Of course, it is general that the presentation engine 177, decoder 19, and planes are designed using hardware. In particular, the constituent elements (for example, constituent elements designated by reference numerals 172, 174, 175, and 176), each of which performs desired processing using software, may constitute a part of the controller 12. Therefore, it should be noted that the above-described constituents and configuration of the present invention be understood on the basis of their meanings, and are not limited to their implementation methods such as hardware or software implementation. Here, “plane” means a conceptual model for explaining overlaying procedures of the primary video, secondary video, PG (presentation graphics), IG (interactive graphics), text sub titles. In accordance with the present invention, the secondary video plane is arranged in front of the primary video plane. Accordingly, the secondary video output after being decoded is presented on the secondary video plane.

FIG. 7 illustrates an exemplary embodiment of the secondary video metadata according to the present invention.

In accordance with the present invention, reproduction of the secondary video is managed using metadata. The metadata includes information about the reproduction time, reproduction size, and reproduction position of the secondary video. Hereinafter, the management data will be described in conjunction with an example in which the management data is PiP metadata.

The PiP metadata may be included in a playlist which is a kind of a reproduction management file. FIG. 7 illustrates PiP metadata blocks included in an ‘ExtensionData’ block of a playlist managing reproduction of the primary video. The PiP metadata may include at least one block header ‘block_header[k]’ 910 and block data ‘block_data[k] 920. The number of the block header and block data is determined depending on the number of metadata block entries stored in PiP metadata. The block header 910 includes header information of the associated metadata block. The block data 920 includes data information of the associated metadata block.

The block header 910 may include a field indicating playitem identifying information (hereinafter, referred to as ‘PlayItem_id[k]’), and a field indicating secondary video stream identifying information (hereinafter, referred to as ’secondary_video_stream_id[k]’). The ‘PlayItem_id[k]’ is a value corresponding to a playitem including an STN table in which ‘secondary_video_stream_id’ entry referred to by ‘secondary_video_stream_id[k ’ is listed. The ‘PlayItem_id’ value is given in the playlist block of the playlist file. In the PiP metadata, the entries of ‘PlayItem_id’ in the PiP metadata are sorted in an ascending order of the ‘PlayItem_id’. The ‘secondary_video_stream_id[k]’ is used to identify a sub path, and a secondary video stream to which the associated block data 920 is applied. That is, it is possible to identify the stream entry corresponding to ‘secondary_video_stream_id[k]’, in the STN table of ‘PlayItem’ corresponding to ‘PlayItem_id[k]’. Since the stream entry is recorded with the value of the sub path identification information associated with the secondary video, the optical recording/reproducing apparatus 10 can identify the sub path, which is used to reproduce the secondary video, based on the recorded value. The playlist block includes a sub path block.

In accordance with the present invention, the type of the sub path used to reproduce the secondary video is classified based on the kind of the stream, in which the secondary video is multiplexed, and whether or not the sub path is synchronous with the main path associated with the sub path. In accordance with the present invention, information as to the sub path type is also recorded in a database file. PiP application models according to the present invention are mainly classified into three types. Therefore, in accordance with the present invention, the kind of the sub path used to reproduce the secondary video, namely, the sub path type, is classified, taking into consideration the three models.

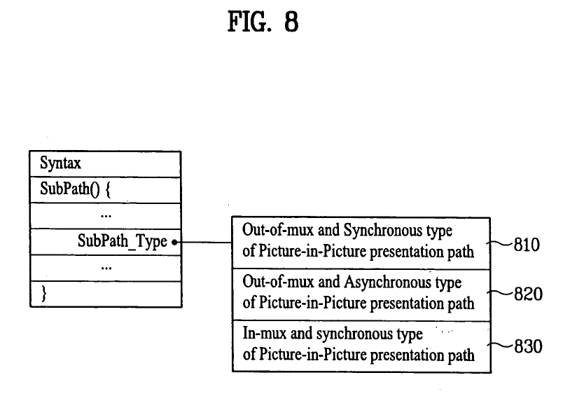

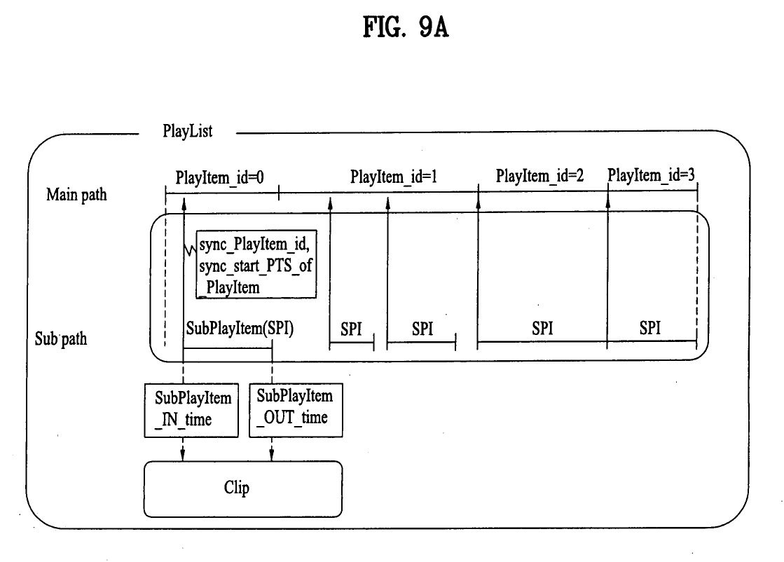

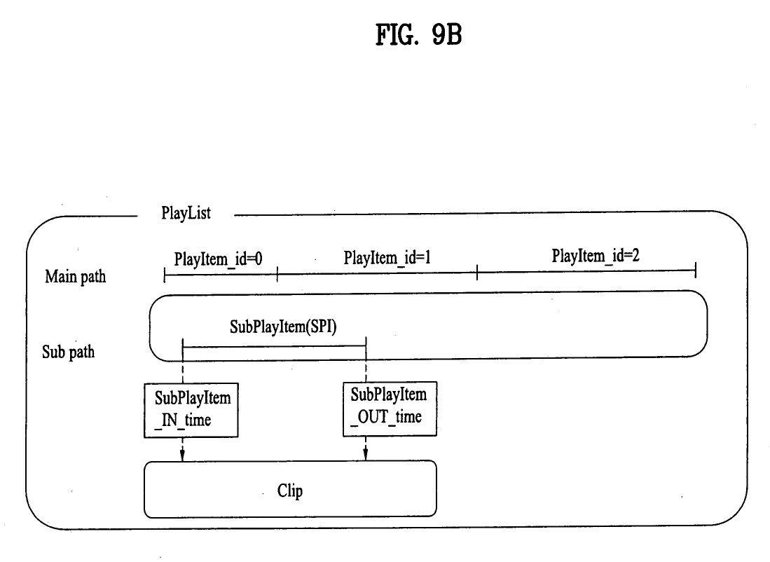

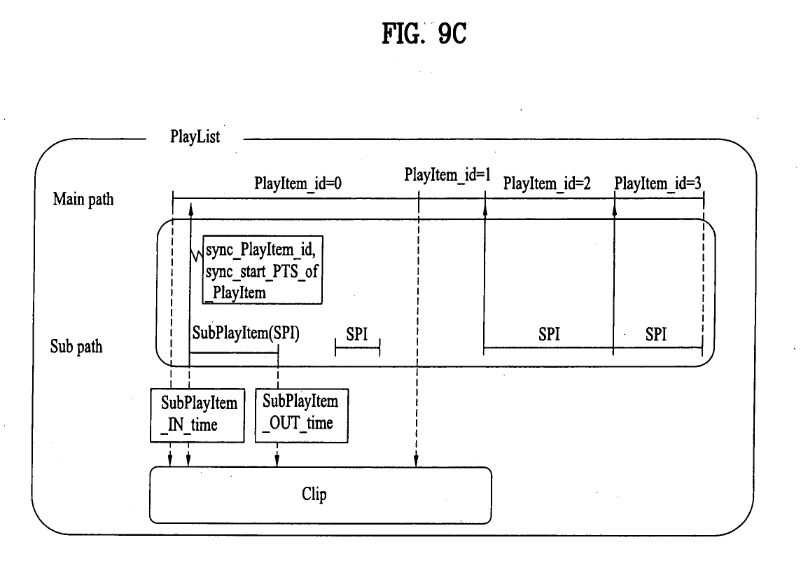

Referring to FIG. 8, the first sub path type is associated with the case in which the secondary video is encoded in a stream different from that of the primary video (e.g., not multiplexed with the primary video—also called out-of-mux), and the sub path used to reproduce the secondary video is synchronous with the main path used to reproduce the primary video (810). The second sub path type is associated with the case in which the secondary video is encoded in a stream different from that of the primary video, and the sub path used to reproduce the secondary video is asynchronous with the main path used to reproduce the primary video (820). The third sub path type is associated with the case in which the secondary video is encoded in the same stream as the primary video (e.g., multiplexed with the primary video - also called In-mux), and the sub path used to reproduce the secondary video is synchronous with the main path used to reproduce the primary video (830). Hereinafter, the sub path types according to the present invention will be described in detail with reference to FIGS. 9A to 9C.

FIGS. 9A to 9C are schematic diagrams for understanding of the sub path types according to the present invention.

FIG. 9A illustrates the case in which the secondary video is encoded in a stream different from that of the primary video, and the sub path is synchronous with the main path (810). The case in which the secondary video is multiplexed in a stream different from that of the primary video, as described above, is referred to as an ‘out-of-mux’ type.

Referring to FIG. 9A, the playlist for managing the primary and secondary videos includes one main path used to reproduce the primary video, and one sub path used to reproduce the secondary video. The main path is configured by four playitems (‘PlayItem_id’=0, 1, 2, 3), whereas the sub path is configured by a plurality of subplayitems. The sub path is synchronous with the main path. In detail, the secondary video is synchronized with the main path, using an information field 'sync-PlayItem_id’, which identifies a playitem associated with each subplayitem, and presentation time stamp information ‘sync_start_PTS_of PlayItem’, which indicates a presentation time of the subplayitem in the playitem. That is, when the presentation point of the playitem reaches a value referred to by the presentation time stamp information, the presentation of the associated subplayitem is begun. Thus, reproduction of the secondary video through one sub path is begun at a time during the reproduction of y video.

In this case, the playitem and subplayitem refer to different clips, respectively, because the secondary video is multiplexed in a stream different from that of the primary video. Each of the playitems and subplayitems includes information as to the reproduction start time IN-Time and reproduction end time OUT-Time of a particular clip to be redproduced. Accordingly, the clip referred to by the associated playitem and subplayitem is supplied to the AV decoder 17b.

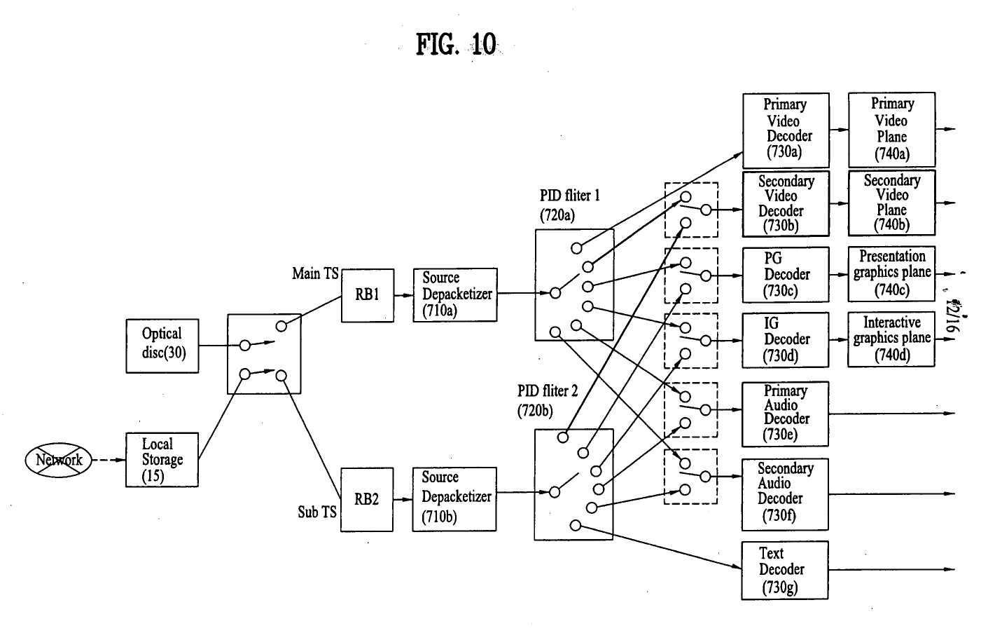

Referring to FIG. 10 schematically illustrating an AV decoder model according to the present invention, the stream file of the above-described clip is supplied to the AV decoder 17b in the form of a transport stream (TS). In the present invention, the AV stream, which is reproduced through a main path, is referred to as a main transport stream (hereinafter, referred to as a “main stream”), and an AV stream other than the main stream is referred to as a sub transport stream (hereinafter, referred to as a “sub stream”). Thus, the primary and secondary videos are supplied to the AV decoder 17b as a main stream and a sub stream, respectively. In the AV decoder 17b, a main stream from the optical disc 30 passes through a switching element to a buffer RB1, and the buffered main stream is depacketized by a source depacketizer 710a. Data contained in the depacketized AV stream is supplied to an associated one of decoders 730a to 730g after being separated from the depacketized AV stream in a PID (packet identifier) filter-1 720a in accordance with the kind of the data packet. As shown, the packets from the PID filter-1 720a may pass through another switching element before receipt by the decoders 730b-730g.

On the other hand, each sub stream from the optical disc 30 or local storage 15 passes through a switching element to a buffer RB2, the buffered sub stream is depacketized by a source depacketizer 710b. Data contained in the depacketized AV stream is supplied to an associated one of the decoders 730a to 730g after being separated from the depacketized AV stream in a PID filter-2 720b in accordance with the kind of the data packet. As shown, the packets from the PID filter-2 720b may pass through another switching element before receipt by the decoders 730b-730f.

That is, the primary video is decoded in a primary video decoder 730a, and the primary audio is decoded in a primary audio decoder 730e. Also, the PG (presentation graphics), IG (interactive graphics), secondary audio, text subtitle are decoded in a PG decoder 730c, an IG decoder 730d, a secondary audio decoder 730f, and a text decoder 730g, respectively.

The decoded primary video, secondary video, PG, and IG are reproduced by a primary video plane 740a, a secondary video plane 730b, a presentation graphics plane 740c, and an interactive graphics plane 740d, respectively. The presentation graphics plane 740c can also reproduce graphic data decoded in the text decoder 730g. The decoded primary and secondary audios are output after being mixed in an audio mixer. Since the sub path used to reproduce the secondary video is synchronous with the main path in the sub path type of FIG. 9A, the controller 12 performs a control operation for outputting the secondary video synchronously with the primary video in this case.

FIG. 9B illustrates the case in which the secondary video is encoded in a stream different from that of the primary video, and the sub path is asynchronous with the main path (820). Similar to the sub path type of FIG. 9A, secondary video streams are multiplexed in a state separate from a clip to be reproduced based on the associated playitem. However, the sub path type of FIG. 9B is different from the sub path type of FIG. 9A in that the presentation of the sub path can be begun at any time on the timeline of the main path.

Referring to FIG. 9B, the playlist for managing the primary and secondary videos includes one main path used to reproduce the primary video, and one sub path used to reproduce the secondary video. The main path is configured by three playitems (‘PlayItem_id’=0, 1, 2), whereas the sub path is configured by one subplayitem. The secondary video, which is reproduced through the sub path, is asynchronous with the main path. That is, even when the subplayitem includes information for identifying a playitem associated with the subplayitem, and presentation time stamp information indicating a presentation time of the subplayitem in the playitem, these informations are invalid in the sub path type of FIG. 9B. Accordingly, the optical recording/reproducing apparatus 10 can operate irrespective of the above-described information used to synchronize the main path and sub path. Thus, the user can view the secondary video at any time during the reproduction of the primary video.

In this case, since the secondary video is encoded in a stream different from that of the primary video, the primary video is provided to the AV decoder 17b as a main stream, and the secondary video is provided to the AV decoder 17b as a sub stream, as described above with reference to FIG. 9A.

FIG. 9C illustrates the case in which the secondary video is encoded in the same stream as the primary video, and the sub path is synchronous with the main path (830). The sub path type of FIG. 9C is different from those of FIGS. 9A and 9B in that the secondary video is multiplexed in the same AV stream as the primary video. The case in which the secondary video is multiplexed in the same stream as the primary video, as described above, is referred to as an ‘in-mux’ type.

Referring to FIG. 9C, the playlist for managing the primary and secondary videos includes one main path and one sub path. The main path is configured by four playitems (‘PlayItem_id’=0, 1, 2, 3), whereas the sub path is configured by a plurality of subplayitems. Each of the subplayitems constituting the sub path includes information for identifying a playitem associated with the subplayitem, and presentation time stamp information indicating a presentation time of the subplayitem in the playitem. As described above with reference to FIG. 9A, each subplayitem is synchronized with the associated playitem, using the above-described information. Thus, the secondary video is synchronized with the primary video.

In the sub path type of FIG. 9C, each of the playitems constituting the main path and an associated one or ones of the subplayitems constituting the sub path refer to the same clip. Accordingly, the secondary video is provided to the AV decoder 17b, along with the primary video, as a main stream. The main stream, which is packetized data including the primary and secondary videos, is depacketized by the source depacketizer 710a, and is then sent to the PID filter-1 720a. Data packets are separated from the depacketized data in the PID filter-1 720a in accordance with associated PIDs, respectively, and are then sent to associated ones of the decoders 730a to 730g, so as to be decoded. That is, the primary video is output from the primary video decoder 730a after being decoded in the primary video decoder 730a. The secondary video is output from the secondary video decoder 730b after being decoded in the secondary video decoder 730b. In this case, the controller 12 performs a control operation for displaying the secondary video in synchronism with the primary video.

The main stream and sub stream may be provided from the recording medium 30 or storage 15 to the AV decoder 17b. In case that the primary and secondary videos are encoded in different clips, respectively, the primary video may be recorded in the recording medium 30, to be provided to the user, and the secondary video may be downloaded from the outside of the recording medium 30 to the storage 15. Of course, the case opposite to the above-described case may be possible. However, where both the primary and secondary videos are stored in the recording medium 30, one of the primary and secondary videos may be copied to the storage 15, prior to the reproduction thereof, in order to enable the primary and secondary videos to be simultaneously reproduced. In case that both the primary and secondary videos are encoded in the same clip, they are provided after being recorded in the recording medium 30. In this case, it is possible that both the primary and secondary videos are downloaded from outside of the recording medium 30.

Referring to FIG. 7, the block header 910 may also include information indicating a timeline referred to by the associated PiP metadata (hereinafter, referred to as ‘pip_timeline_type’). Hereinafter, PiP timeline types according to the present invention will be described with reference to FIGS. 11A to 11C.

FIGS. 11A to 11C are schematic diagrams for understanding of secondary video timeline types according to embodiments of the present invention.

The block data 920 may include time stamp information indicating a point where PiP metadata is placed (hereinafter, ‘pip_metadata_time_stamp’). The ‘pip_timeline_type[k]’ is classified in accordance with the type of the timeline referred to by the entries of the above-described ‘pip_metadata_time_stamp[i]’, namely, the type of the timeline referred to by PiP metadata. Hereinafter, PiP timeline types will be described in detail with reference to ‘pip_timeline_type[k]’ and ‘pip_metadata_time_stamp[i]’.

In the PiP timeline type of FIG. 11A, the sub path used to reproduce the secondary video is synchronous with the main path, and the entries of ‘pip_metadata_time_stamp’ refer to the timeline of the playitem indicated by PiP metadata. In FIG. 11A, ‘pip_metadata_time_stamp’ points to presentation time from the intervals that the associated subplayitem intervals are projected on the timeline of the playitem referred to by ‘PlayItem_id[k]’. In the timeline type of FIG. 11A, ‘pip_metadata_time_stamp[0]’ and ‘pip_metadata_time stamp[m]’ are put at the beginning points 101a and 105a of each of the intervals that the associated subplayitem intervals are projected on the timeline of the playitem referred to by the ‘playitem_id[k]’, respectively.

The block data 920 includes at least one block of secondary video composition information (hereinafter, referred to as ‘pip_composition_metadata’), the number of which is determined by the number of ‘pip_metadata time_stamp’. The i-th ‘pip composition_metadata’ is secondary video composition information which is valid between ‘pip_metadata_time_stamp[i]’ 102a and ‘pip_metadata_time_stamp[i+1]’ 103a. The last ‘pip_composition_metadata’ in one block data 920 is valid until the presentation end time 104a of the sub path indicated by ‘secondary_video_stream_id[k]’ included in the PiP metadata.

The secondary video composition information is information indicating the reproduction position and size of the secondary video. Referring to FIG. 7, the secondary video composition information may include position information of the secondary video, and size information of the secondary video (hereinafter, referred to as ‘pip_scale[i]’). The position information of the secondary video includes horizontal position information of the secondary video (hereinafter, referred to as ‘pip_horizontal_position[i]’), and vertical position information of the secondary video (hereinafter, referred to as ‘pip_vertical_position[i]’). The information ‘pip_horizontal_position’ represents a horizontal position of the secondary video displayed on a screen when viewing from an origin of the screen, and the information ‘pip_vertical_position’ represents a vertical position of the secondary video displayed on the screen when viewing from the origin of the screen. The display size and position of the secondary video on the screen are determined by the size information and position information.

In the timeline type of FIG. 11A, the sub path indicated by the above-described ‘secondary_video_stream_id[k]’ corresponds to the sub path type 810 or 830 described with reference to FIG. 9A or 9C because the sub path used to reproduce the secondary video, namely, the PiP presentation path, is synchronous with the main path.

In the timeline type of FIG. 11A, the secondary video refers to the timeline of the main path because the secondary video is reproduced synchronously with the playitems presented through the main path. That is, when the main path jumps or moves back to a certain position, the secondary video is reproduced according to the position and scale information of the ‘pip_metadata_time_stamp’ associated with time to which reproduction of the main path has jumped or moved back or Accordingly, secondary video streams are reproduced along the timeline of the main path.

FIG. 11B illustrates the case in which the PiP presentation path is asynchronous with the main path, and the timeline of the sub path is referred to by the entries of ‘pip_metadata_time_stamp’. In the embodiment of FIG. 11B, the sub path indicated by the above-described ‘secondary_video_time_stamp id[k]’ corresponds to the sub path type 820 described in conjunction with FIG. 9B because the PiP presentation path is asynchronous with the main path. In the timeline type of FIG. 11B, ‘pip_metadata_time_stamp’ indicates a presentation time of the interval of the subplayitem indicated by ‘secondary_video_stream_id[k]’ included in the PiP metadata. In this timeline type, ‘pip_metadata_time_stamp[O]’ is placed at the beginning point 101b of the subplayitem.

In the timeline type of FIG. 11B, the secondary video is reproduced through the sub path, irrespective of the reproduction procedure through the main path, because the secondary video refers to the timeline of the subplayitem. That is, the timeline type of FIG. 11B is different from the timeline type of FIG. 11A in that, even when the presentation point of the main path is changed to a certain point on the timeline of the playitem reproduced through the main path, the presentation position and scale of the secondary video does not change.

In the timeline type of FIG. 11B, the PiP presentation path is asynchronous with the main path, as described above. Accordingly, the sub path indicated by the above-described ‘secondary_video time_stamp_id[k]’ corresponds to the sub path type 820 described in conjunction with FIG. 9B.

FIG. 11C illustrates the case in which the PiP presentation path is asynchronous with the main path, and the timeline of the playitem referred to by ‘PlayItem_id[k]’ included in the PiP metadata is referred to by the entries of ‘pip_metadata_time_stamp’. Similar to the timeline type of FIG. 11A, the timeline of the playitem is referred to in the timeline type of FIG. 11C. Accordingly, ‘SubPlayItem_IN_time’ is projected on the timeline of the playitem at a point 102c. In the timeline type of FIG. 11C, ‘pip_metadata_time_stamp’ indicates a presentation time of the interval of the playitem indicated by ‘PlayItem_id[k]’. In the timeline type of FIG. 11C, ‘pip_metadata_time_stamp[0] is placed at the beginning point 101c of the interval of the playitem indicated by ‘PlayItem_id[k]’ because the Pip metadata refers to the time line of the play item indicated by ‘PlayItem_id[k]’. The timeline type of FIG. 11C is similar to the timeline type of FIG. 11A. In the case of the timeline type of FIG. 11C, ‘pip_metadata_time_stamp[0]’ is placed at the begining point 101c of the interval of the playitem. However, in the case of the timeline type of FIG. 11A, ‘pip_metadata_time_stamp[O]’ is put at the beginning point 101a of the interval that the associated subplayitem interval is projected on the timeline of the playitem referred to by the ‘playitem_id[k]’.

In the timeline type of FIG. 11C, when the presentation point of the main path jumps or moves back to a certain position, the metadata at that position is applied to the secondary video. ‘This is because Pip metadata refers to the timeline of the playitem in the timeline type of FIG. 11C. Referring to FIG. 11C, it can be seen that, for example, when the presentation position of the main path moves back from the position of ‘pip_metadata_time_stamp[i+1]’ to the position of ‘pip_metadata_time_stamp[i]’ under the condition in which ‘pip_composition_metadata[i+1]’ corresponding to ‘pip_metadata time_stamp[i+1]’ has been applied to the secondary video, ‘pip_composition_metadata[i]’ corresponding to ‘pip_metadata time_stamp[i]’ is applied to the secondary video.

In the timeline type of FIG. 11C, ‘pip_data time_stamp[i+1]’ is valid until the out time 104c of the current playitem because PiP metadata indicates the presentation time in the interval of the playitem referred to by ‘PlayItem_id[k]’. After the subplayitem ut time 103c, however, the secondary video is no longer displayed because the last ‘pip_composition_metadata’ in one block data 920 is valid until the presentation end time of the sub path indicated by ‘secondary_video_stream_id[k]’.

In the timeline type of FIG. 11C, the sub path indicated by the above-described ‘secondary_video_time_stamp_id[k]’ corresponds to the sub path type 820 described in conjunction with FIG. 9B because the PiP presentation path is asynchronous with the main path.

Although the reproduction time information and composition information of PiP metadata has been described as being included in the playlist, in the embodiment of FIG. 7, they may be included in the headers of secondary video streams implementing PiP.

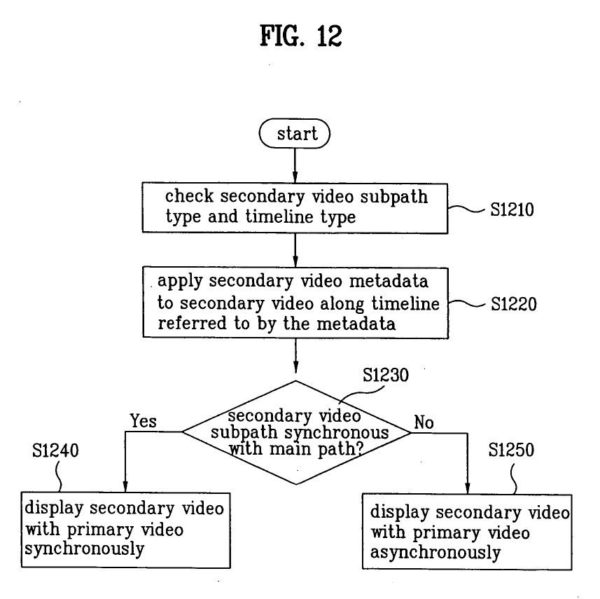

FIG. 12 illustrates an exemplary embodiment of a data reproducing method according to the present invention.

In case that a data reproduction command is generated, the reader unit, which may be the pickup 11, reads data from the recording medium 30 or storage 15. The controller 12 checks PiP metadata contained in the data. Based on the PiP metadata, the controller 12 checks the sub path type of the sub path, which is used to reproduce the secondary video, and the timeline type referred to by the PiP metadata (S1210).

Thereafter, the PiP metadata is applied to the secondary video along the timeline (the timeline of the playitem or subplayitem) identified based on the timeline type (S1220). Referring to FIG. 11A, the PiP metadata is applied to the secondary video, starting from ‘pip_composition_metadata’ corresponding to ‘pip_metadata_time_stamp[0]’, because ‘pip_metadata_time_stamp’ indicates a presentation time in the interval of the playitem on which the presentation interval of the subplayitem is projected. At ‘pip_metadata_time_stamp[i]’ 102a, ‘pip_composition_metadata’ corresponding to ‘pip_metadata_time_stamp[i]’ 102a, particularly, ‘pip_horizontal_position[i]’, ‘pip_vertical_{‘}position[i]’, and ‘pip_scale[i]’, are applied to the secondary video. The ‘pip_horizontal_position[i+1]’, ‘pip_vertical_position[i+1]’, and ‘pip_scale[i+1]’ are applied to the secondary video for an interval from ‘pip_metadata_time_stamp[i+1]’ 103a to the out time 104a of the subplayitem.

Based on the PiP metadata applied in the above-described manner, the secondary video is displayed on the primary video. At this time, the controller 12 determines whether or not the sub path used to reproduce the secondary video is synchronous with the main path used to reproduce the primary video (S1230). In case that the sub path corresponds to the sub path type of FIG. 9A or 9C, the controller 12 performs a control operation for displaying the secondary video synchronously with the primary video (S1240). On the other hand, in case that the sub path corresponds to the sub path type of FIG. 9B, it is unnecessary to synchronize the secondary video with the primary video. In this case, accordingly, the controller 12 can perform a PiP application at any time in accordance with the request of the user (S1250).

In case that the sub path corresponds to the sub path type of FIG. 9A or 9B, the secondary video is provided to the AV decoder 17b as part of a sub stream. On the other hand, in case that the sub path corresponds to the sub path type of FIG. 9C, the secondary video is provided to the AV decoder 17b as part of a main stream.

In accordance with the present invention, the method for reproducing the secondary video is varied depending on the type of the sub path, and the timeline type of metadata for the secondary video. Accordingly, there are advantages in that it is possible to efficiently reproduce the secondary video along with the primary video, and to implement more diverse secondary video.

As apparent from the above description, in accordance with the recording medium, data reproducing method and apparatus, and data recording method and apparatus of the present invention, it is possible to reproduce the secondary video simultaneously with the primary video. In addition, the reproduction can be efficiently carried out. Accordingly, there are advantages in that the content provider can compose more diverse contents, to enable the user to experience more diverse contents.

It will be apparent to those skilled in the art that various modifications and variations can be made in the present invention without departing from the spirit or scope of the inventions. Thus, it is intended that the present invention covers the modifications and variations of this invention.

What is claimed is:

1. A recording medium having a data structure for managing reproduction of at least one picture-in-picture presentation path, comprising:
a data area storing a primary video stream and a secondary video stream, the primary video stream representing a primary presentation path, the secondary video stream representing a picture-in-picture presentation path with respect to the primary presentation path; and
a management area storing management information for managing reproduction of the picture-in-picture present path, the management information indicating a type of the secondary video data stream based on whether the secondary video data stream is multiplexed with the primary video data stream.

2. The recording medium of claim 1, wherein the management information includes a sub path type information field indicating whether the secondary video stream is one of a multiplexed type of picture-in-picture presentation path and a not multiplexed type of picture-in-picture presentation path.

3. The recording medium of claim 2, wherein the data area stores the primary video stream and the secondary video stream in a single file if the sub path type information field indicates the secondary video stream is multiplexed with the primary video stream, and stores the primary video stream and the secondary video stream in separate files if the sub path type information field indicates the secondary video stream is not multiplexed with the primary video stream.

4. The recording medium of claim 1, wherein the management information includes a sub path type information field indicating one of a plurality of picture-in-picture presentation path types, and at least one of the types indicates whether the secondary video stream is multiplexed with the primary video stream.

5. The recording medium of claim 1, wherein the management information further indicates whether the secondary video stream is stored in a same file in the data area as the primary video stream.

6. A recording medium having a data structure for managing reproduction of at least one picture-in-picture presentation path, comprising:
a data area storing a primary video stream and a secondary video stream, the primary video stream representing a primary presentation path, the secondary video stream representing a picture-in-picture presentation path with respect to the primary presentation path; and
a management area storing management information for managing reproduction of the picture-in-picture presentation path, the management information indicating whether the secondary video stream is multiplexed with the primary video stream.

7. The recording medium of claim 6, wherein the management information further includes presentation timing information indicating a timing of when to display the secondary video stream with the primary video stream.

8. The recording medium of claim 6, wherein the management information further includes a playitem identifier identifying a playitem of the primary video stream with which the secondary video stream is to be reproduced.

9. A recording medium having a data structure for managing reproduction of at least one picture-in-picture presentation path, comprising:
a data area storing a primary video stream and a secondary video stream, the primary video stream representing a primary presentation path, the secondary video stream representing a picture-in-picture presentation path with respect to the primary presentation path; and
a management area storing management information for managing reproduction of the picture-in-picture present path, the management information indicating a type of the secondary video stream based on whether the secondary video stream is stored in a same file as the primary video stream.

10. A method of managing reproduction of at least one picture-in-picture presentation path, comprising:
reproducing management information for managing at least reproduction of a picture-in-picture presentation path from the recording medium, the management information indicating a type of the picture-in- picture presentation path based on whether a secondary video stream is multiplexed with a primary video stream, the primary video stream representing a primary presentation path, the secondary video stream representing the picture-in-picture presentation path with respect to the primary presentation path; and
reproducing the primary video stream and the secondary video stream based on the management information.

11. The method of claim 10, wherein the management information includes a sub path type information field indicating whether the secondary video stream is one of a multiplexed type of picture-in-picture presentation path and a not multiplexed type of picture-in-picture presentation path.

12. The method of claim 11, wherein the reproducing the primary video stream and the secondary video stream step reproduces the primary video stream and the secondary video stream from a single file if the sub path type information field indicates the secondary video stream is multiplexed with the primary video stream, and reproduces the primary video stream and the secondary video stream from separate files if the sub path type information field indicates the secondary video stream is not multiplexed with the primary video stream.

13. The method of claim 10, wherein a sum of bit rates of the primary and secondary video streams is less than or equal to a set value.

14. The method of claim 10, wherein the secondary video stream has a same scan type as the primary video stream.

15. A method of managing reproduction of at least one picture-in-picture presentation path, comprising:
reproducing management information for managing at least reproduction of a picture-in-picture presentation path from the recording medium, the management information indicating whether a secondary video stream is multiplexed with a primary video stream, the primary video stream representing a primary presentation path, the secondary video stream representing the picture-in-picture presentation path with respect to the primary presentation path; and
reproducing the primary video stream and the secondary video stream based on the management information.

16. The method of claim 15, wherein the reproducing the primary video stream and the secondary video stream step comprises: decoding a primary video stream in data reproduced from the recording medium using a first decoder; and
decoding a secondary video stream in the reproduced data using a second decoder.

17. The method of claim 15, wherein the management information further includes presentation timing information indicating a timing of when to display the secondary video stream with primary video stream.

18. A method of managing reproduction of at least one picture-in-picture presentation path, comprising:
reproducing management information for managing at least reproduction of a picture-in-picture presentation path from the recording medium, the management information indicating a type of the picture-in- picture presentation path based on whether a secondary video stream is stored in a same file as a primary video stream, the primary video stream representing a primary presentation path, the secondary video stream representing the picture-in-picture presentation path with respect to the primary presentation path; and
reproducing the primary video stream and the secondary video stream based on the management information.

19. The method of claim 18, further comprising:
decoding the secondary video stream using a different decoder than a decoder used to decode the primary video stream.

20. An apparatus for managing reproduction of at least one picture-in- picture presentation path, comprising:
a driver configured to drive a recording device to reproduce data from the recording medium; and
a controller configured to control the driver to reproduce management information for managing at least reproduction of a picture- in-picture presentation path, the management information indicating a type of the picture-in-picture presentation path based on whether a secondary video stream is multiplexed with a primary video stream, the primary video stream representing a primary presentation path, the secondary video stream representing the picture-in-picture presentation path with respect to the primary presentation path; and
the controller configured to control the driver to reproduce the primary video stream and the secondary video stream based on the management information.

21. The apparatus of claim 20, further comprising:
a first decoder configured to decode the primary video stream; and
a second decoder configured to decode the secondary video stream.

22. The apparatus of claim 20, wherein the management information further includes presentation timing information indicating a timing of when to display the secondary video stream with primary video stream.

23. A method of recording a data structure for managing reproduction of at least one picture-in-picture presentation path, comprising:
recording a primary video stream and a secondary video stream in a data area of the recording medium, the primary video stream representing a primary presentation path, the secondary video stream representing a picture-in-picture presentation path with respect to the primary presentation path; and
recording management information for managing reproduction of the picture-in-picture presentation path in a management area of the recording medium, the management information indicating a type of the picture-in-picture presentation path based on whether the secondary video stream is multiplexed with the primary video stream.

24. The method of claim 22, wherein the recording a primary video stream and a secondary video stream step records the primary and secondary video streams such that the primary and secondary video stream can be separated from a data stream reproduced from the recording medium and decoded by separate decoders.

25. An apparatus for recording a data structure for managing reproduction of at least one picture-in-picture presentation path, comprising:
a driver configured to drive a recording device to record data on the recording medium;
a controller configured to control the driver to record a primary video stream and a secondary video stream in a data area of the recording medium, the primary video stream representing a primary presentation path, the secondary video stream representing a picture-in-picture presentation path with respect to the primary presentation path; and
the controller configured to control the driver to record management information for managing reproduction of the picture-in-picture presentation path in a management area of the recording medium, the management information indicating a type of the picture-in-picture presentation path based on whether the secondary video stream is multiplexed with the primary video stream.

26. The apparatus of claim 25, wherein the management information further includes a playitem identifier identifying a playitem of the primary video stream with which the secondary video stream is to be reproduced.

27. The apparatus of claim 25, wherein the management information further includes presentation timing information indicating a timing of when to display the secondary video stream with primary video stream.

28. The apparatus of claim 24, wherein the controller is configured to control the driver to record the primary video stream and the secondary video stream such that the primary and secondary video stream can be separated from a data stream reproduced from the recording medium and decoded by separate decoders.
